(19) United States
(12) Patent Application Publication
(10) Pub. No.: US 2010/0318893 A1
(43) Pub. Date: Dec. 16, 2010

(54) Online document annotation and reading system

(76) Inventors: Brett Matthews, Martinez, CA (US); Andrew Bathgate, Orinda, CA (US); Tulio Solorzano, Walnut Creek, CA (US); Robert Kirby, Lafayette, CA (US); Michael Brown, Davis, CA (US)

Correspondence Address: Lee Pederson, 712 East Main Street, Sleepy Eye, MN, 56085, US

(21) Appl. No.: 12/798,450

(22) Filed: Apr. 3, 2010

Related U.S. Application Data
(60) Provisional application No. 61/211,802, filed on Apr. 4, 2009.
(60) Provisional application No. 61/270,249, filed on Jul. 3, 2009.

(51) Int. Cl. G06F 17/00

(52) U.S. Cl. 715/230

(57) ABSTRACT

An online system provides users with tools to annotate publications and share such annotations with other users. Publications annotated by a community of users become a richer source of information for the community.

### PRIORITY CLAIMS

This application claims priority to United Stated provisional patent application No. 61/211,802 entitled “ONLINE DOCUMENT ANNOTATION AND READING SYSTEM” and filed on Apr. 4, 2009; and to United Stated provisional patent application No. 61/270,249 entitled “ONLINE DOCUMENT ANNOTATION AND READING SYSTEM” and filed on Jul. 3, 2009.

### FIELD OF THE INVENTION

The present invention relates to reading, viewing and annotating web-based documents. More particularly, this aspect of the present invention relates to annotating web-based documents in such a way as to provide easily searchable supplemental content and context.

The present invention also relates to social networking based on common reading interests. More particularly, this aspect of the present invention relates to interactively reading web-based documents with a community of users. Members of community meet and interact with each other via the social network.

The present invention also relates to online advertising. More particularly, this aspect of the invention includes a marketplace where publishers make advertising space available to ad buyers.

### BACKGROUND OF THE INVENTION

Annotations have been around for as long as there have been books. Highlights, underlines, and notes written in the margins are examples of such annotations. Annotated bibliographies provide descriptions about how sources are used in constructing a paper or argument. Such comments may provide summaries, express relevance, or include ideas inspired by the underlying document. In the case of internet annotations, many of the same benefits are shared and improved upon. Links from online documents to related materials are one such improvement.

Because of the open nature of the internet, there is often too much information to sort through given a limited amount of time. Also, specific groups of individuals may share unique interests apart from the world-wide online community. For these reasons, there is a continuing need to streamline information sharing and gathering processes.

### BRIEF DESCRIPTION OF THE INVENTION

An online system provides users with tools to annotate publications and share such annotations with other users. Publications annotated by a community of users become a richer source of information for the community.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 depicts operation of the system to read a publication after a plurality of annotations have been associated with a specific document or publication.

FIG. 2 depicts a community of users viewing the same publication.

FIG. 3 depicts an instance of a user employing the system to read and/or annotate a publication.

FIG. 4 depicts a decomposition of an annotation

FIG. 5 provides an overview of the system.

FIG. 6 depicts an embodiment of a display screen as seen by a user.

FIG. 7 depicts the annotation filter.

FIG. 8 is a flow diagram of a user creating an annotation.

FIG. 9 is a flow diagram of a user searching for annotations based on quality data related to the annotations.

FIG. 10 is a flow diagram of a user searching for annotations based on an area of interest in a WBD.

FIG. 11 depicts a system for allowing a user to search for annotations based on an area of interest in a WBD.

FIG. 12 depicts a system for displaying targeted advertising to readers of online publications.

### DETAILED DESCRIPTION

Embodiments of the present invention are described herein in the context of a system for creating, reading and filtering annotations to web-based documents (WBDs). Reference will now be made in detail to implementations of the present invention as illustrated in the accompanying drawings. The same reference indicators will usually be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Those of ordinary skill in the art will realize that the following description of the present invention is illustrative only and not in any way limiting. Other embodiments of the invention will readily suggest themselves to such skilled persons having the benefit of this disclosure.

The invention involves a computer network based system for reading and annotating documents by a community of users. Such documents may be referred to as web-based documents (WBDs), publications, or other similar terms. Such documents may represent text, images, and/or video. The system allows a user to access a document and associate one or more annotations to any part of the document as chosen by the user. Each annotation is stored in a database and made available to other users in the community. Subsequent readers of the document may view the annotations to enhance their experience of viewing the document. Each user in the community has the opportunity to read the underlying document and its associated annotations and/or add further annotations according to their own interests. An annotation filter incorporated into the system provides the user with the ability to control the source and quality of the annotations according to criteria chosen by the user.

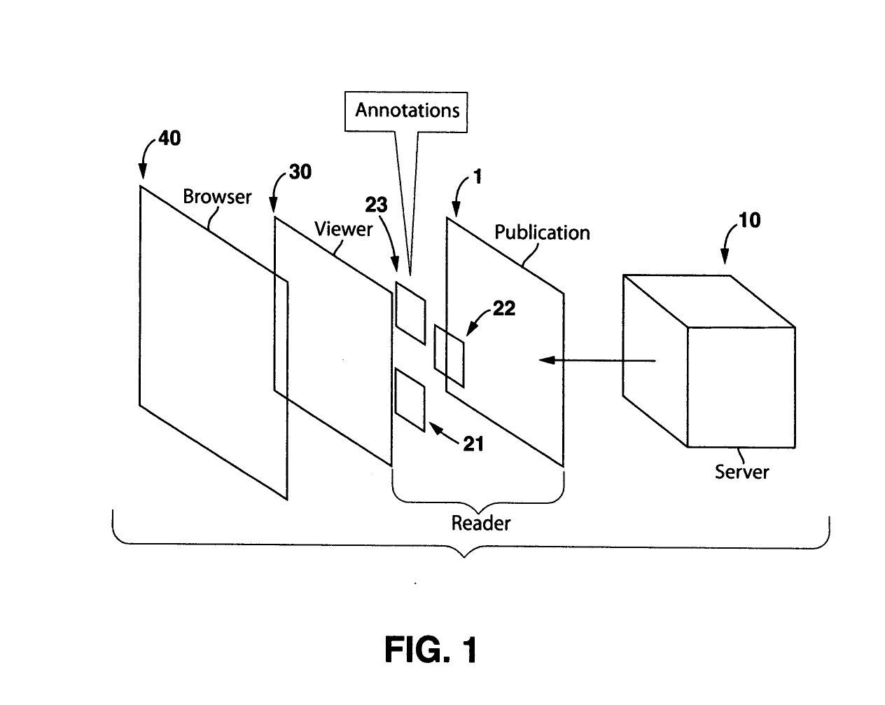

FIG. 1 depicts operation of the system to read a publication after a plurality of annotations have been associated with a specific document or publication. A user (not shown) employs a browser 40 and viewer or reader 30 to retrieve a publication 1 hosted on one or more servers, hereafter referred to as the server 10. Server 10 also hosts a database including a plurality of annotations 21, 22, and 23. The viewer 30 may display the publication 1 with highlights to annotations. When the user clicks on a specific highlight associated with a particular part of the publication, the viewer 30 will display the annotation provided by a previous user and stored in the database.

The viewer is implemented as web-based software, and is compatible with a variety of browsers.

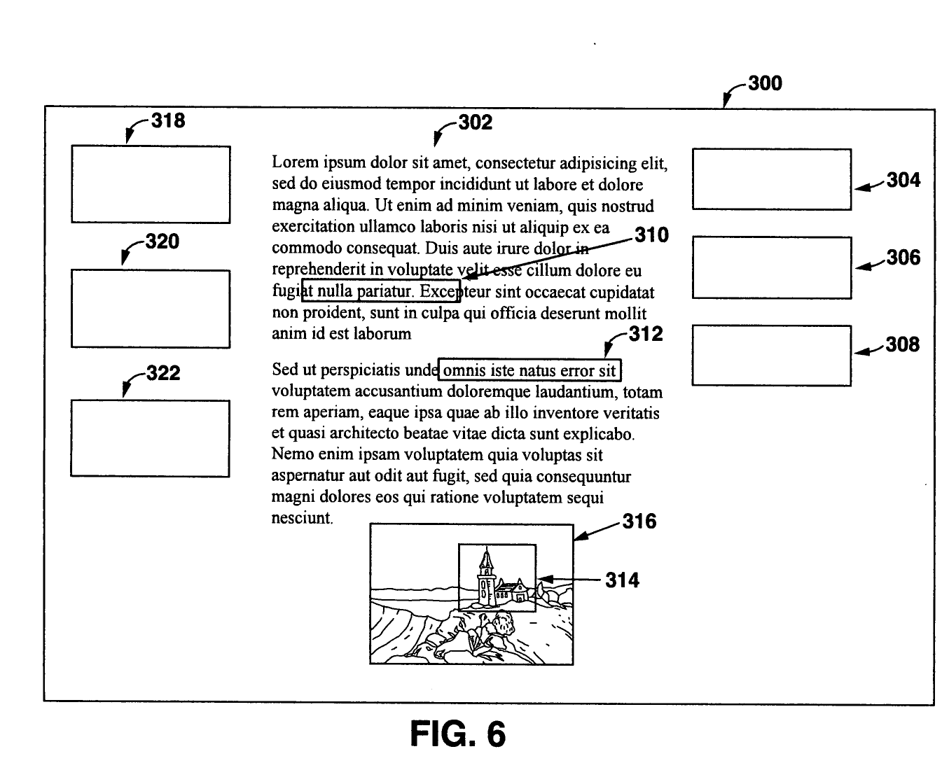

The viewer provides a variety of presentation options for a user to select from when viewing a WBD. FIG. 6 shows one such presentation option of a screen 300 displayed by the viewer software. The screen 300 includes a page of a WBD 302 having text and an image 316. WBD is scalable, so a user may adjust the image size according to the user's own preferences. Highlights 310, 312 and 314 are visible to show that users have created annotations relating to particular parts of the WBD. Highlights may be implemented as icons or colored areas, for example. A separate portion of screen 300 (in this case, the right side) exhibits annotation boxes 304, 306 and 308 corresponding to the highlights. Display of annotation boxes may change as selected by the user and depending on the number of annotations displayed. Highlight 310 is correlated with annotation box 304. When the cursor is positioned over highlight 310, annotation box 304 is visibly highlighted so that the user can see the correlation. The annotation in the annotation box may include text, links, videos and/or images. If an annotation is short, the annotation may be entirely visible within the box as shown. Alternatively, a user may click on the box to enlarge it to show extended text.

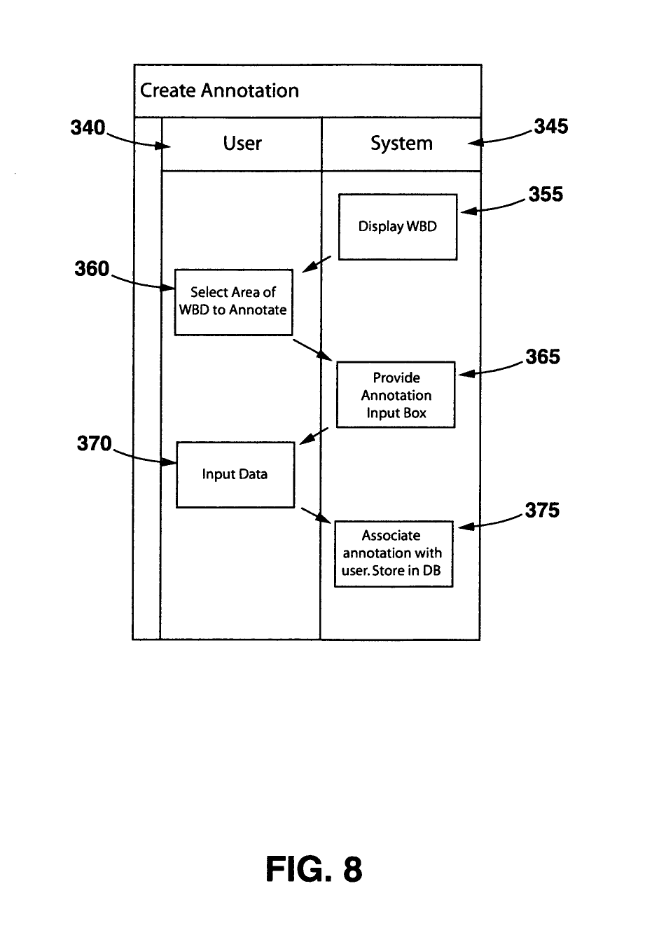

To create an annotation a user selects the portion of the WBD that they want to annotate (typically using a mouse), thereby creating a highlight at the selected area. Then a dialogue box appears in which the user can enter the annotation. When the user is done, the new annotation is stored in the database and is available for viewing by further users. FIG. 8 is a flow diagram of a user creating a new annotation. As stored in the database, the annotation is associated with the selected portion of the WBD as well as with data relating to the creator. Ranking information provided by other users may subsequently also be associated with the annotation. Besides annotations associated with specific areas of the WBD, it is also possible to create annotations associated with the WBD as a whole.

Another portion of the screen (in this case, the left side) may display information boxes showing community information, session information, information regarding the WBD, and other information as desired. Information boxes 318, 320, and 322 may be set to display, among other items: the screen names of other users who are currently viewing the document, the screen names of users who have left annotations, instant messages from other users in the community, video from other users, a personal notebook for recording notes, and annotation filter settings as described below.

Presentation options made available by the viewer include auto zoom based on screen size, zoom in/zoom out capability, paging up and down and scrolling through documents, tables of contents with links, search capability, embedding of audio and visual feeds, and dynamic insertion of additional pages into documents for contextual advertising.

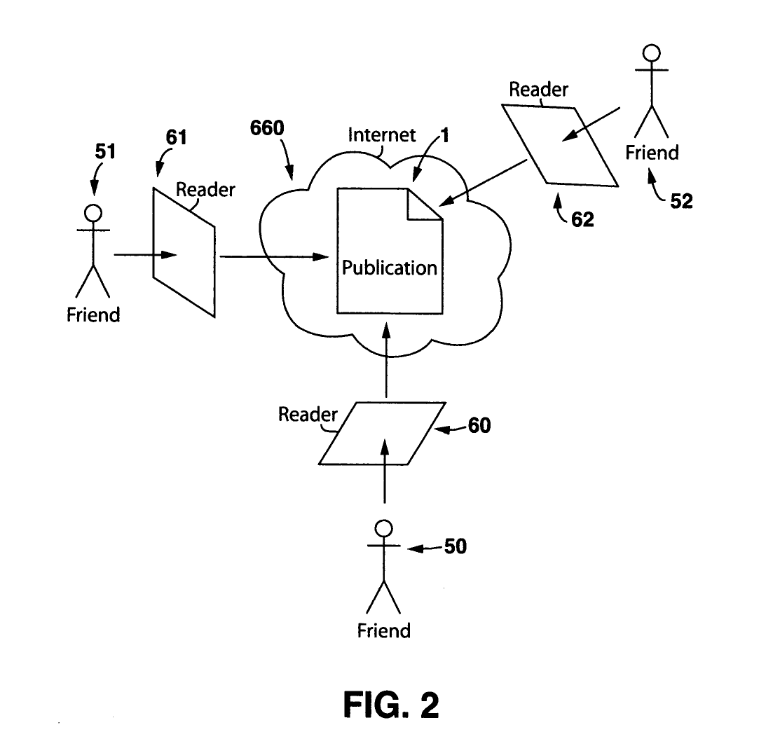

A primary advantage of the system is to provide a user in a community of users access to knowledge, opinions, commentary, and related content contributed by other users. FIG. 2 depicts such a community of users viewing the same publication. Users 50, 51, and 52 each employ their own viewer or reader 60, 61, and 62 to view publication 1. While viewing the publication, they may also view annotations from the database and/or add new annotations of their own. Such viewing and annotating may be done at any time according to the needs and interests of each user.

Communities of users may be defined in many ways. In the broadest since, the largest community includes everyone who uses the system. Within this universe of users, however, smaller groups may be defined. For example, a community may include a class of students who are all using the same textbook which is available on the system as a publication. In this case, the community of students may add their annotations as part of a joint learning experience. In another example, the community may include subscribers to a magazine that is available on the system as a publication. Other communities may be defined in others ways including by groups of friends, people who share common interests, and people who share an interest in a particular publication.

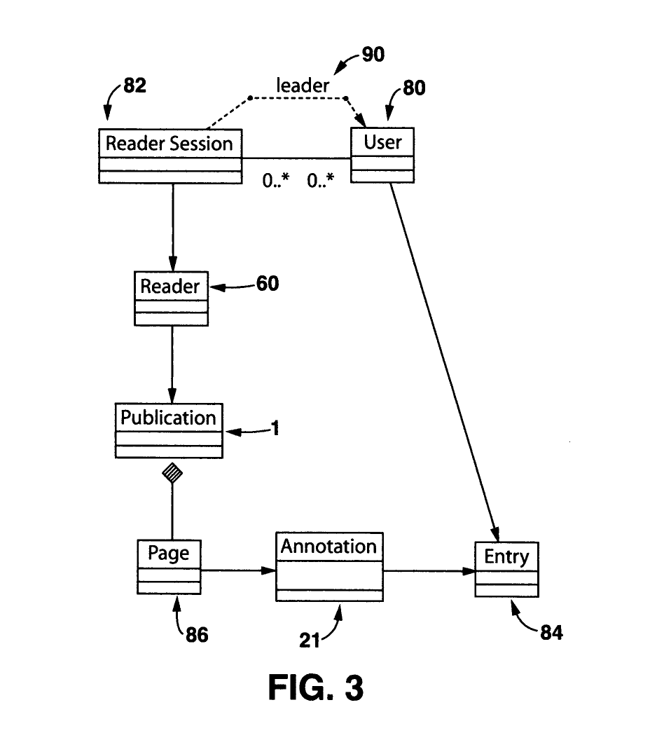

FIG. 3 depicts an instance of a user 80 employing the system to read and/or annotate a publication 1. User 80 employs the reader 60 to open a reader session 82. User selects publication 1 from the library (not shown). User may view the publication 1 one page 86 at a time. User may view existing annotations (not shown) associated with the page 86. User may also use the entry function 84 to create a new annotation associated with a particular part of the page 86.

In a preferred embodiment, each page of a publication is stored in the library as a pdf file and converted to an swf file when opened by a user. Each page includes a coordinate system that maps every pixel on the page. When a user chooses to annotate a part of the page, the user employs a mouse to select the words/image/portion of the page that they wish to annotate, thereby creating an annotation link (visible as a highlight) that is visually layered over the page. The coordinate system relates the annotation link to the portion of the page selected by the user so that the position of the annotation link relative to the information on the page does not change if the page is resized by the browser or viewer. Once the annotation link is created, the user then adds the content of the annotation. The software routine that links annotations to particular portions of a WBD may be referred to as a scaling engine.

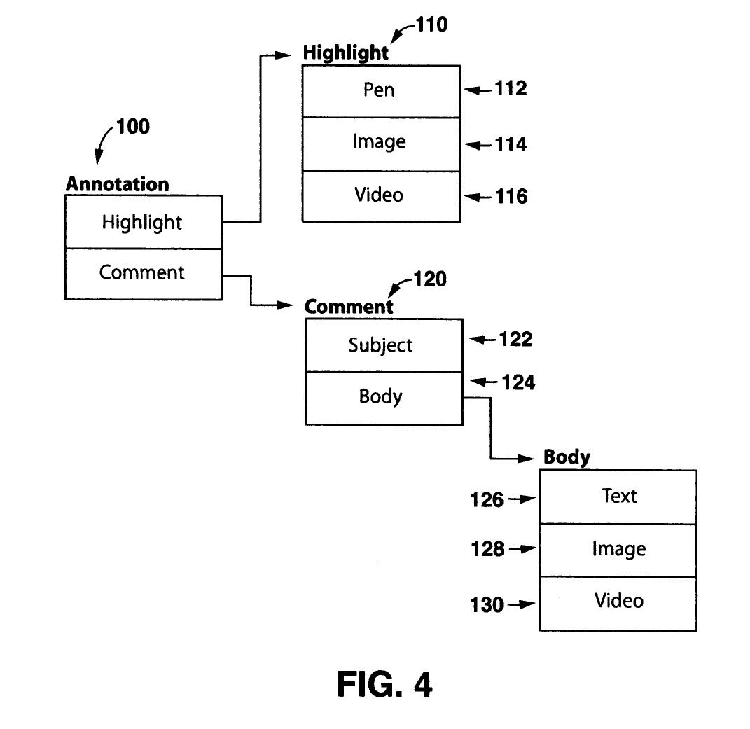

FIG. 4 depicts a decomposition of an annotation 100. Annotation 100 is comprised of an annotation link or highlight 110 and the content of the annotation or comment 120. The highlight 110 may be a colored geometric figure or “pen” 112. In a preferred embodiment, the pen 112 is displayed as a yellow box evoking a student highlighter pen. Alternatively, the highlight 110 may be displayed as an icon or image 114. As described below, subsequent viewers may use the filter to change the display of the highlight to something different than that created by the annotator. The content of the annotation or comment 120 includes a subject heading 122 and the body 124. The subject heading is simply a headline. The body is the substantive portion of the annotation and may include text 126, images 128 or video 130. Hyperlinks may also be included in the body.

Further information is linked to each annotation and stored in the database. As described below, this information may be filtered by a subsequent user to select annotations that are most likely to be useful for the subsequent user. Such further information may include, but is not limited to, the screen name of the annotator, personal data regarding the annotator, community affiliations of the annotator, the time and date the annotation was made, ranking information related to the annotator or annotation that is produced by the community in response to the annotator or annotation, and further commentary on the annotation. The categories of further information may be referred to as quality types, as these types of information may reflect on the quality of the annotation either directly (as in ranking data) or indirectly. For example, a filterable field may be the date that a particular annotation was created. A quality type for that field might then be a range of dates. In other words, a quality type is a particular description of an aspect of an annotation. Quality types may be assigned by the creator of the annotation (e.g., argument in favor) or assigned by the system (e.g., accumulated ranking data).

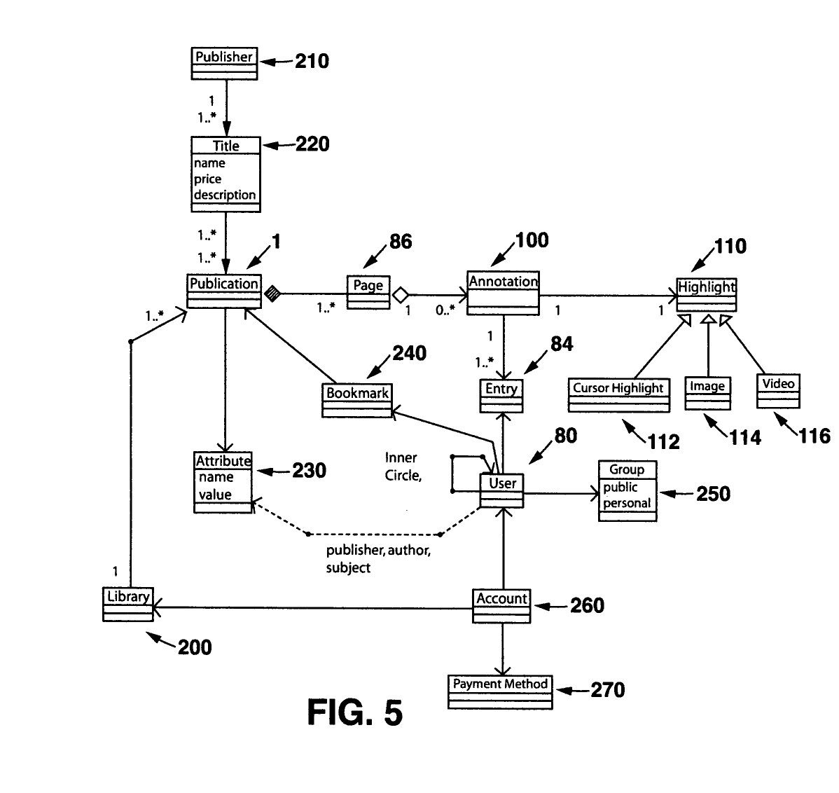

FIG. 5 provides an overview of the system. Library 200 stores all the publications, e.g., publication 1, in server (10 in FIG. 1). Publications may come from a variety of sources. Some may be documents that are in the public domain. Other publications may be contributed by community members. In some cases a publisher 210 may make arrangements to provide a title 220 for access via the system. An electronic version of the title may be sold through the system. The title may be a book, magazine, article, video, image, or other content that may be electronically distributed. User 80 may access publications stored in library 200. If required, subscription fees and purchase prices are electronically debited from user's account 260 via a selected electronic payment method 270. Once user has accessed a publication 1, user may read and annotate publication 1 as previously described. User may elect to join a user group 250. Such a group may be comprised of personal friends, or people with common interests.

Users may create individual accounts within the system. Such accounts may be associated with a screen name visible to other users, and also associated with annotations made on behalf of the account. Individual accounts may have both private and public functions. Private functions include passwords, payments, subscriptions, reading and browsing logs, annotations for personal use. Public functions include contributing annotations to the community and group memberships. Instant messaging, video-conferencing and exchange, and audio messaging and exchange may be used in conjunction with individual accounts. The system may store data related to both personal and private functions and use it to enhance the user experience. Such enhancements may include featuring titles from the bookstore that the user may be interested in, recommending reading groups having users with similar social graphs, and recommending reading events.

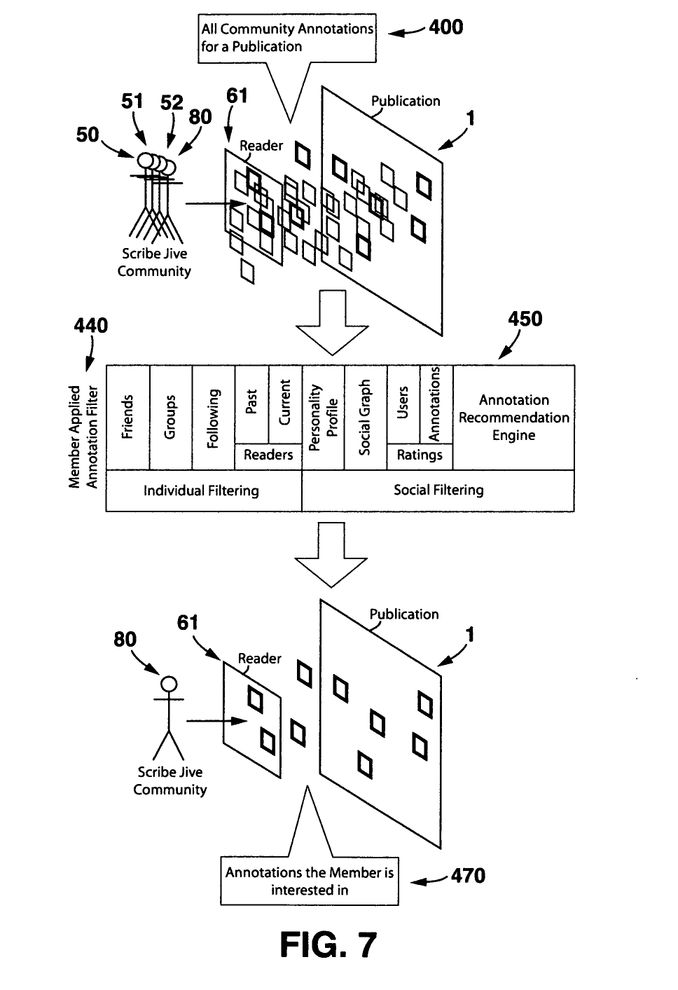

FIG. 7 depicts the annotation filter. A given publication 1 may have numerous annotations 400 (represented by clear and hashed squares). The potential community of users, represented by users 50, 51, 52, and 80 may each use their own reader or viewer 61 to view the publication 1 and its associated annotations 400. However, not all the annotations will be useful for any one user. Each user may therefore employ the annotation filter 440 to limit the annotations displayed by the reader 61.

The annotation filter 440 employs instructions from the user in conjunction with information associated with each annotation to select the annotations most likely to be useful for the individual user. Filtering falls into two general categories: individual filtering and social filtering.

Individual filtering uses information identifying an individual annotator, or relating to personal affiliations of an individual annotator. Examples include groups comprised of friends, and students taking a particular class together. Another type of individual filtering might select annotations made by respected commentators and experts such as professors, columnists and commentators, and political leaders. In some cases, viewing these annotations may require payment by the user via a subscription. Another category of individuals is based on past or current readers.

Social filtering relies on information related to the content of the annotation, and values assigned to individual annotators independent of the personal affiliations of the individual annotators. One type of social filtering employs personal data provided by annotators. Such data may include age, gender, family history, hobbies, political views, education, employment and other information. A user may filter annotations by selecting to view annotations made by individuals with certain defined backgrounds. For example, when reading a passage in a sociology textbook a user may select to see only annotations by women professors between the ages of 50 and 60 who have children. In another method of social filtering, the personal data may be processed by an annotation recommendation engine 450 which uses personal data, as well as the reading, ranking, and annotating history of individual users, to produce social graphs relating individual users. The annotation recommendation engine preferably uses Pearson's correlations and/or Euclidean distance algorithms to associate similar tastes and suggest annotations (and further recommended reading) based upon weighted rankings of interests and ratings of similarly tagged documents.

Rankings may also be used in social filtering. The system provides users multiple ways to provide ranking information. A user may rank individual publications, either numerically or by commentary. Users may also rank the usefulness of particular annotations, either numerically or by commentary. All ranking information is stored in the database. The annotation recommendation engine uses the ranking information (and other information) to quantify the pair wise relationship between the viewpoints of any two users. Based on these pair wise quantifications, a user may select annotations from individuals with similar or divergent views to their own.

Still referring to FIG. 7, user 80 may select criteria based on individual filtering, social filtering, or a combination of the two. Based on these criteria, annotation filter 440 provides a subset of the universe of community annotations for viewing, such subset being the annotations in which the user is interested 470 (indicated by hashed squares). Alternatively, a user may simply ask the annotation recommendation engine 450 to provide annotations based on information stored in the database.

FIG. 8 is a flow diagram of a session where a user 340 creates an annotation using the system. As the system displays a WBD 355 or portion thereof, user selects an area of the WBD to annotate 360. When annotating text, this may be done by using a mouse to outline the particular text to be annotated and indicating to the system that the user desires to create an annotation. Like most procedural steps in the invention, this process may be implemented in a variety of ways using a variety of interfaces, e.g., mouse, touch screen, or voice recognition. The system responds by presenting an annotation input box 365 or equivalent, where the user may the input data 370. Again, this procedural step may be implemented in a variety of ways, e.g. keyboard or microphone, to name just two. When data input is complete, the system stores the new annotation in the database, where it is associated with the user and the selected area of the WBD.

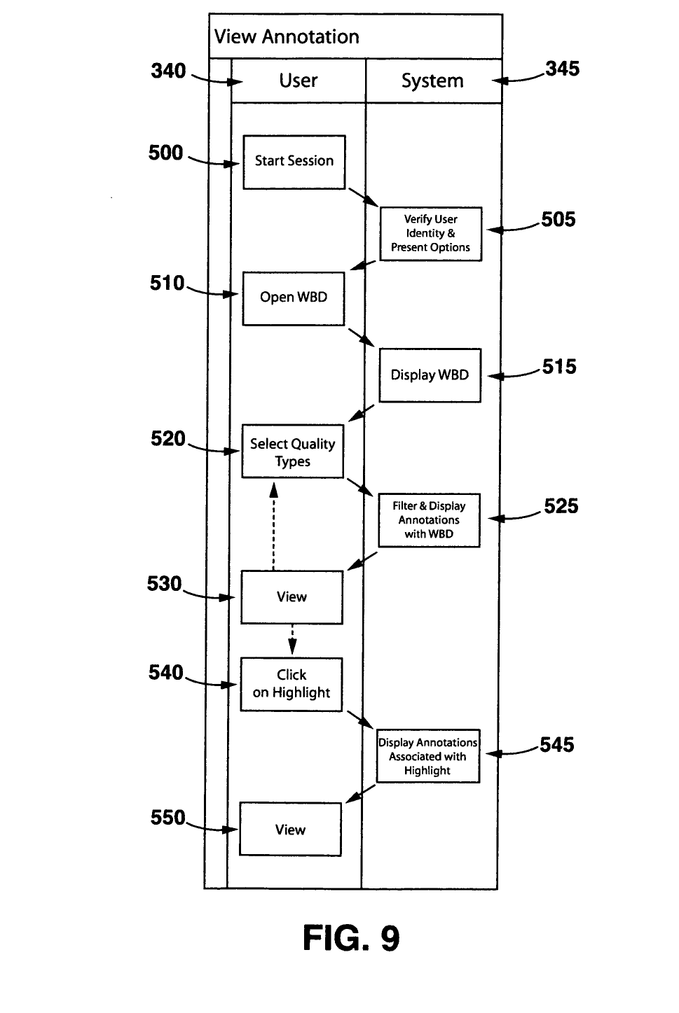

FIG. 9 is a flow diagram of a user searching for annotations based on quality data related to the annotations. The session begins with the user logging in to the system 500. The system verifies the identity of the user and presents options to the user 505. The user opens a WBD of interest 510. The system then displays the WBD, or a portion thereof 515. The user then selects the criteria for annotations that might be helpful 520. Such criteria may be referred to as quality types. The system then filters annotations to the WBD based on the quality types selected by the user and displays them in the context of the WBD 525. The user then views the filtered annotations 530. The user may refine his search for annotations by selecting new quality types 520 and/or continue reading the document with the filtered annotations. Depending on the presentation screen, an annotation may be short enough to be fully readable in an annotation presentation box. If only a portion of the annotation is viewable in the annotation presentation box, the user may click on the box to enlarge it and view the complete annotation. Also depending on the presentation screen, the user may click on a highlight to view a particular annotation 540. The system then displays the annotation associated with the highlight 545 for the user to view 550.

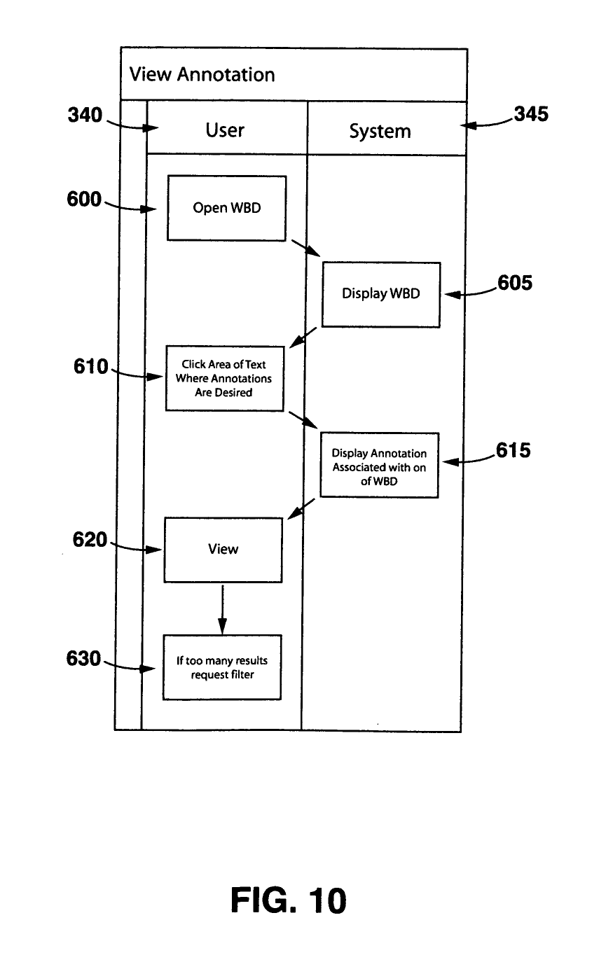

FIG. 10 is a flow diagram of a user searching for annotations based on an area of interest in a WBD. When the user sends a request to open a particular WBD 600, the system responds by displaying the WBD 605. Depending on the presentation screen selected by the user, highlights may be visible on the WBD indicating the existence of annotations. The user clicks on an area of the WBD to which annotations are desired 610. The system then displays annotations associated the selected portion of the WBD 615. The user may then view these annotations 620. If there are too many results, or if the current annotation filter settings are yielding less than optimal annotations, the user may select additional or alternate filtering 630.

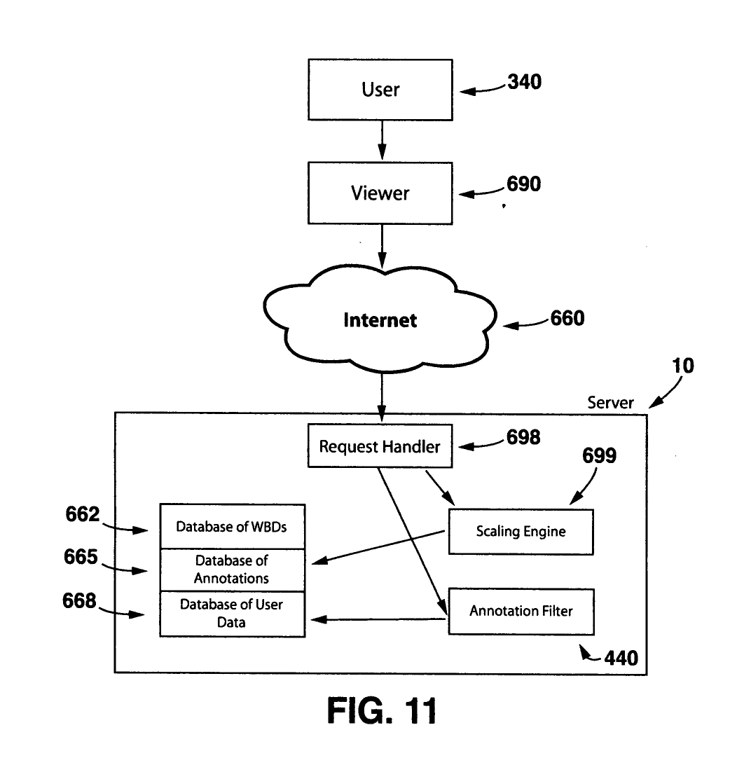

FIG. 11 depicts a system for allowing a user to search for annotations based on an area of interest in a WBD. User 340 employs a viewer 650 connected over the internet 660 to a server. The server hosts data and software to implement the system. Data stored in the system includes WBDs 662, annotations 665, and user information 668. The data is integrated by associations of various types. For example, each annotation is associated with a WBD, usually a particular portion of a WBD. Each annotation is also associated with the user who created it, and also with users who have ranked the annotation or the annotator. While viewing a WBD, user 340 may wish to see annotations associated with a certain portion of the WBD. Depending on display options selected by user 340, highlights indicating the existence of annotations may be visible to the user. To view annotations associated with the area of interest, user sends a request to the system. The request includes information indicating the area of the document, and may also include directions to filter annotations. The request is handled by request handler 698 which communicates with scaling engine 699 and annotation filter 440 to retrieve appropriate annotations from the database. These annotations are then displayed to the user.

Not all annotations must be associated with a particular area or segment of the WBD. Some annotations may instead apply to the entire document, and therefore not be linked to any specific content in the WBD. Given the existence of such annotations, it is still understood that the system provides sets (or subsets) of annotations where each annotation is associated with a particular area or segment of the WBD.

The system typically hosts WBDs available for annotation. This is especially true for content supplied by book, magazine, and educational material publishers. However, the system is also useful for annotation of virtually all WBDs generally available on the internet. To apply the system for annotation of WBDs not originally hosted by the system, a variety of approaches may be employed. In one such approach, the desired WBD is captured and then simply rehosted by the system. In this case, the system operates essentially as described above. Other approaches may also be used to customize annotatability for generally available WBDs.

In one such implementation, a desktop application allows collaborative annotation by a defined internet community. Specific WBDs are selected by members of the community and then rehosted for access by the community. Users may access these WBDs, download the community's collective activity, and then view all associated information (annotations, chat, comments) offline. Modifications made by users offline are later uploaded to enrich the community's store of information.

In another such implementation, the system would not host the WBDs at all. Instead, the system would just store pointers and scaling information regarding a WBD, and then hash any page that a user annotates. When later uses request annotations for the WBD, hashes are compared to see if the WBD has changed.

Social Reading.

Another aspect of the invention includes a system and method allowing for collaborative social reading. While the physical act of reading is typically an individual activity, reading brings people together by providing a context to discuss matters of common interest, whether such matters are factual, historical, educational, speculative, humorous, religious, or any other descriptive category. The present invention provides various ways to connect readers having common interests.

One implementation of social reading includes hosted reading events. Typically an author or expert or teacher leads such an event, which occurs at a scheduled time. The viewer display for the event typically includes live video of the leader, a book or story of interest viewable as a WBD, chat and/or IM boxes, as well as annotation boxes. Participants may interact by annotating the WBD and by posing questions to the leader. Annotations and communications made during the event may be specially flagged so that the annotation filter can later recreate the event. Participants may use the annotation filter during the event to choose messages and annotations from other participants with selected characteristics.

Another implementation of social reading includes reading and annotation of publications by a community of users, where each user participates in the reading and annotation in a largely unstructured fashion. Users may independently choose documents to read, times at which to read them, and the extent that they wish to participate in annotation, messaging and discussion with other community members.

Yet another aspect of social reading involves the formation of book clubs related to particular authors, genres, magazines, artists and other common interests. Such book clubs may be scheduled to meet at regular times, or structured more loosely.

Because the system continually collects personal information from users, another aspect of social reading is to use such information to suggest introductions between users for social, business and romantic purposes.

Virtual Backpacks.

A primary application of the system is in the educational arena. The system allows educational institutions and their students the ability to coordinate textbooks, syllabi, videos, graphics and other materials in an efficient fashion. For each course a student registers for, the appropriate learning materials can be loaded into the student's account, where the student can access them from anywhere. Without a visit to a bookstore or the need to carry heavy textbooks, each student can be equipped with all their study materials. Additionally, the learning experience is enhanced by the ability to share annotations on their assignments with teachers and fellow classmates. Further, the cohort of students in any program can be expanded in time in space. Instead of sharing the learning experience with a single classroom of schoolmates, the community becomes all students studying the same materials regardless of their location. Plus, annotations and guidelines from previous classes are archived and accessible for current students.

Advertising Marketplace.

Yet another aspect of the invention includes an advertising marketplace employing true target marketing. Because the system incorporates demographic profiles of every user, the system can display advertising more likely to be of interest to the user. The advertising model is based on the notion of an electronic billboard (“eBillboard”). The power behind this is that the content of the billboard can change based on who is looking at it. Therefore unlike traditional print media (e.g., print magazines) where the advertising is static, the electronic billboard is dynamic. This allows a new way of selling advertising space based on time. In print media advertising space is sold based on how much space an advertisement takes and the position of the ad in the magazine. The system adds a dimension based on time. Space can be sold based on size, position and how long the ad is actually displayed to the reader. The time dimension may be based on a percentage. For example, if an ad buyer purchases 100% of a particular advertising space in an online publication, their ad will always be displayed. If they purchase 50% of the display time in the same space, their ad will be displayed 50% of the time and other advertising will display the other 50%.

Targeted advertising is enhanced by criteria set by advertisers to direct advertising to the most likely consumers of the advertised products and services. When a publication is added to the system, the publisher fills out a publication profile describing the publication's content as well as the reader base. This provides the system's advertising engine with demographic information on the publication. Additionally, advertising buyers provide demographic information on who the product/service is targeted to. The system's advertising engine then uses this information and compares it to the demographic information associated with the publications to come up with a list of publications that have readers best suited for purchasing the product/service. The ad buyer then selects the publications they want to advertise in and the time percent the add will display. The ad may be an image, video or a Flash file.

Because the system incorporates data regarding each user's social network, the advertising engine also knows who a reader's friends are. The system can then display the same ad to all friends who have similar interests, thereby reinforcing effectiveness of the advertising.

When a reader is looking at a magazine with a page which contains an eBillboard, the advertising engine looks at who purchased the billboard space, matches the reader's demographics to the advertiser's product demographics and displays a suitable ad.

Another final component to the system's advertising capability is custom catalogs. The advertising engine has the ability to generate a custom shopping catalog for every user. This catalog may be delivered to the user's library each month and contains advertisements targeted for just that user.

An affiliate program may also be incorporated. With an affiliate program, users may create their own adds for products which are then served up to their friends. If a sale is made from the ad, the add creator gets a cut. Also, every sale increases the ad's success rating and then the advertising engine expands the ad out to the next level of the social graph.

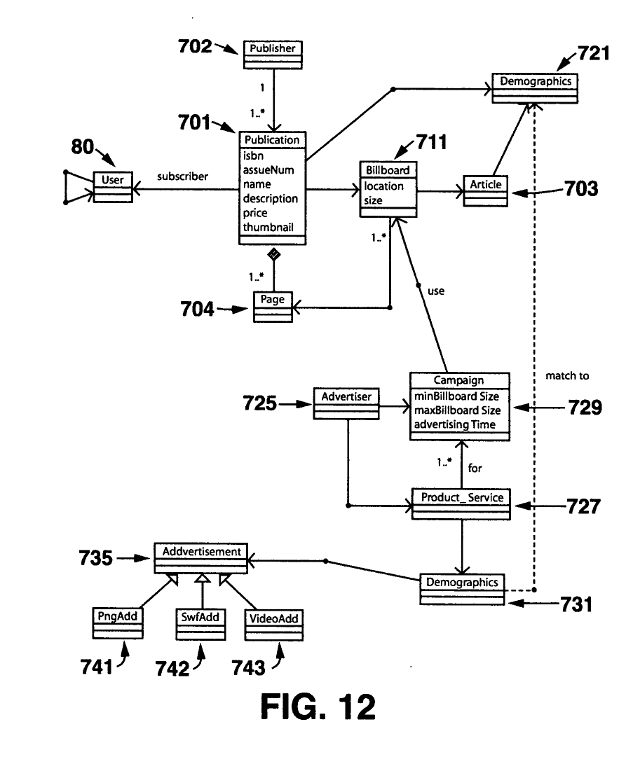

FIG. 12 depicts a system for displaying targeted advertising to readers of online publications. In the figure, user 80 views a publication 701 produced by publisher 702. The publication typically comprises a plurality of pages (e.g., 704). The publication may include a number of individual articles (e.g., 703). The pages may include spaces for billboard advertisements 711. The publication 701 and optionally the article 703 are associated with a first set of demographics 721.

An advertiser 725 wishing to promote a product or service 727 may initiate an advertising campaign 729. The product or service 727 is associated with a second set of demographics. An advertising display engine (not shown) compares the first and second sets of demographics and determines the most effective ad placements. Because there are multiple products and services to be matched with multiple publications and articles, the advertising display engines may use demographic and other data about individual users to optimize ad placements. As a result, an appropriate advertisement 735 is displayed on the billboard 711. The advertisement may be a static ad 741, a flash ad 742, a video ad 743 or any other multimedia ad (not shown).

Additional System Features.

The invention encompasses a complete integrated system for enhancing learning and education, self-expression, information exchange, social networking and literary commerce. As such, many features may optionally be incorporated into the system. An online bookstore may sell electronic and paper copies of books, magazines, videos, music and the like. The bookstore may present featured titles to users based on user preferences and promotional programs sponsored by publishers. The bookstore may recommend titles based on user tastes and community recommendations. Users may rate, review and comment on various publications. Users may personally organize the content they are interested in. Best seller lists may be compiled. Titles may be displayed with information on how many people are reading them at the moment, past reading histories, and availability of social reading sessions. Free previews may allow users to view selections from items in the bookstore. Certain titles may be made available for free. The system may assist in securing and enforcing intellectual property rights for content providers. Detailed real-time reports may be made available to publishers and other content providers. Publishers and content providers may be provided with web pages to explain themselves. Product bundles, promotions, coupons, subscription cards and the like may be enabled. Personalized catalogs, contact list and directories may be made available. Free promotional items may be provided. Self-publishing services also may be included in the system.

### OBJECTS OF THE INVENTION

It is an object of the invention to write and save annotations linked to regions of online read only documents such as magazines and books. These annotation-regions can be highlighted. Annotations can be optionally reviewed and ranked by others. Other users' annotations can be imported into documents. Annotations can be filtered by individual, group or ranking (e.g. show annotations of top 5 ranked annotaters). Annotations may be subscribed to. For example, you can read a newspaper with the annotations provided by leading commentators. Annotation types may be introduced—e.g. pros and cons, critics, help, Cliff notes.

It is another object of the invention to provide a forum for social reading events. Groups of users can read a magazine/book simultaneously and interactively; chatting (text, vocal, video) and annotating. Social reading events can be led by authors like book shop reading events. Social networking techniques can be used to form groups of people with shared interests who come together to read collaboratively. Social reading events may be scheduled. Special study groups can be organized.

It is a further object of the invention to expanding the concept of annotations and social reading events beyond text documents. Any content viewable on the web is apt for annotations and social reading.

It is a further object of the invention to detect changes on dynamic pages to detect if the pages are unchanged and therefore if annotations are still relevant. Partial hashing may be used for partially dynamic pages—i.e. the page may be split into portions based on divs, or simple percentages of the individual pages. Then if half the page changes the annotations are still relevant for the other half.

It is a further object of the invention to allow annotations on advertisements, including advertisements on magazines, newspapers, and other periodicals published on the system. Ads may be detected by signature or by hashing images greater than a cut off size.

It is a further object of the invention to provide contextual help to users viewing a particular publication. With large numbers of people highlighting regions of documents and providing annotations it becomes possible to provide a search mechanism that is much simpler than web-wide searches. If a user reads something they don't understand or for which they want more information, they may simply request annotations by clicking or highlighting the area. The user does not need to think up search criteria. This function can be provided even with dynamic web pages given the hashing mechanisms described above.

It is a further object of this invention to provide school reading lists and virtual back packs for students, i.e., students may be provided access to course materials selected by teachers and available for reading, study, and annotations. Schools and universities it may use the system to provide students with pre-packaged reading lists made available in their accounts. Teachers and other education providers may make recommended sets of annotations available to enhance the content of course materials. Additionally, students in particular classes could form groups to maintain their own sets of annotation as a learning aid. Such annotation sets can be maintained for use by subsequent classes.

It is a further object of the invention to help users finding new recommended reading materials based on their similarities with other users. Using information stored in the database, including lists of favorite books and magazine as well as ranking data, a Pearsons correlation or Euclidean distance algorithm or other means can associate similar tastes to suggest reading based upon weighted rankings of interests and ratings of similarly tagged documents.

It is a further object of the invention to create a marketplace where publishers can make their advertising space available to ad buyers. Ad buyers can then easily buy add space across several magazines or other publications.

Social reading, or group reading, of a publication is one of the primary applications of the system. Group reading may be scheduled in advance, and led by a group leader (indicator 90 in FIG. 3). The group leader may be the author of the publication, or an expert in the field of the selected publication.

In one aspect, the invention includes a computer-based system for allowing a first user in a community of users to read an annotated web-based document (WBD) and associated annotations. The system comprises a WBD; a plurality of annotations associated with the WBD, where each annotation is associated with one or more filterable fields and where each filterable field may store a description (quality type) related to the annotation or to a second user in the community of users who created the annotation, and where each annotation may be associated with an area of the WBD; and a filter controlled by the first user, where the filter selects one or more annotations from the plurality of annotations based on the instructions of the first user and the information in the filterable fields. The WBD may be hosted on an array of servers. The annotations may be hosted on the same array of servers. The plurality of annotations may be created by the community of users. The WBD may be comprised of one or more pages and each page may have a spatial coordinate system, and one or more annotations may be associated with a set of coordinates in a page of the WBD. The filter may select one or more annotations from the plurality of annotations based upon a set of coordinates chosen by the first user. One or more of the filterable fields may store a ranking generated by the community of users. The ranking may be a ranking of the quality of the annotation. The ranking may be a ranking of the quality of a second user. One or more of the filterable fields may store a defined quality type (description) chosen by the annotator. The quality type may be selected from the group consisting of further explanation, further reading, arguments in favor, arguments against, video, and music. The community may be an educational class of users. The community may be a group of friends. The community may be led by a person who is a leader in the field of the publication. The first user may pay a subscription fee to view the annotations of the leader. The system may further comprise an annotation recommendation engine. The annotation recommendation engine may generate a personality profile based on information supplied by a user. A social graph may created by a pair wise comparison based on information supplied by the first user and another user. The annotation recommendation engine may generate a recommendation based upon a broad selection of all data stored in the system. The area of the WBD associated with an annotation may be displayed as a highlight. The annotation may be concurrently displayed in an annotation box.

In another aspect, the invention is a method for allowing a user to select preferred annotations to view concurrently with a WBD in an online system for collaboratively annotating and reading a WBD. The method comprises providing a set of annotations associated with the WBD, where the annotations are created by individual members in a community of users and where each annotation is associated with one or more descriptions (quality types) in one or more filterable fields, and some of the annotations are also each individually associated with an area of the WBD; allowing a user viewing the WBD to select one or more descriptions in one or more filterable fields; filtering the set of annotations based on the selected quality types to produce a subset of annotations; and displaying a subset of filtered annotations to the user with the WBD. The method may further comprise allowing a user viewing the WBD to select an area of the WBD before filtering. The descriptions may be selected from the group consisting of the identification of the member who created the annotation, ranking data related to the annotation, ranking data related to the member who created the annotation, and affiliations of the member who created the annotation.

In another aspect, the invention includes a method of filtering annotations by a user. In this aspect, in an online system for collaborative annotating and reading of a WBD, the invention is a method for a user to select annotations to view concurrently with the WBD, the method comprising: accessing a server hosting the WBD and a set of annotations associated with the WBD, where the annotations are created by individual members in a community of users and each annotation is associated with one or more descriptions in one or more filterable fields, and each annotation is also associated with an area of the WBD; selecting a WBD and one or more descriptions; and viewing the WBD and the provided annotations. The method may further comprise clicking on an area of the WBD; and viewing an annotation associated with the area of the WBD. The area of the WBD may be highlighted by the system to indicate the existence of an annotation. The descriptions may be selected from the group consisting of the identification of the member who created the annotation, ranking data related to the annotation, ranking data related to the member who created the annotation, and affiliations of the member who created the annotation.

In another aspect, the invention is a method to allow search of a WBD. In this aspect, in an online system for collaboratively annotating and reading a WBD, the invention is a method for allowing a user to select annotations to view concurrently with the WBD, the method comprising: providing a set of annotations associated with the WBD, where the annotations are created by individual members in a community of users and each annotation is associated with one or more descriptions in one or more filterable fields, and each annotation is also associated with an area of the WBD; allowing a user viewing the WBD to select an area of the WBD; and displaying the annotations associated with the area of the WBD. The method may further comprise allowing the user to select one or more descriptions in one or more filterable fields; filtering the set of annotations based on the selected descriptions to produce a subset of annotations; and presenting a subset of filtered annotations to the user with the WBD.

In another aspect, the invention is a method for a user to search a WBD. In this aspect, in an online system for collaboratively annotating and reading of a WBD, the invention is a method for a user to select annotations to view concurrently with the WBD, the method comprising: accessing a server hosting the WBD and a set of annotations associated with the WBD, where the annotations are created by individual members in a community of users and each annotation is associated with one or more descriptions in one or more filterable fields, and each annotation is also associated with an area of the WBD; selecting an area of the WBD; and viewing the WBD and the provided annotations. The method may further comprise selecting one or more descriptions in one or more filterable fields; and viewing the annotations associated with both the area of the WBD and the descriptions.

In another aspect, the invention is a system that allows a user to search a WBD. In this aspect, in a computer-based system for allowing a first user in a community of users to read an annotated web-based document (WBD) and associated annotations, the invention is a system comprising: a WBD; a plurality of annotations associated with the WBD, where each annotation is associated with one or more filterable fields and where each filterable field is capable of storing information related to the annotation or to a second user in the community of users who created the annotation, and where each annotation is associated with an area of the WBD; a viewer that displays the WBD and allows the user to select an area of the WBD; a scaling engine that finds annotations associated with the selected area of the WBD. The system may further comprise a filter controlled by the first user, where the filter selects one or more annotations from the plurality of annotations based on the instructions of the first user and the information in the filterable fields.

In another aspect, the invention is a system that allows a group of people to read and share comments on a WBD. In this aspect, the invention is a system for allowing a plurality of users in a community of users to jointly read and annotate a WBD, the system comprising: a server hosting the WBD; an annotation creation routine, said routine allowing a first user to create an annotation associated with an area of the WBD, said annotation associated with one or more filterable fields where each filterable field may store information related to the annotation or to the first user; and a viewer allowing a second user to view the WBD and the annotation.

In another aspect, the invention is a method for a group of people to read and share comments on a WBD. In this aspect, the invention is a method of simultaneous annotating and reading a WBD by two or more users and a group leader in a community of users, the method comprising: a first user opening the WBD on a first viewer, the document being comprised of one or more pages and each page having a spatial coordinate system; a second user opening the WBD on a second viewer while the first user has the WBD open; the group leader opening the WBD on a third viewer while both the first user and the second user have the WBD open; the group leader communicating to the first user and the second user while the first user and the second user read the document; the first user selecting a set of spacial coordinates on a page of the WBD; and the first user creating an annotation associated with the special coordinates. Communicating by the group leader may be by web-based instant messaging, web-based audio and web-based video. The method may further comprise the second user communicating to the group leader and the first user. Communicating by the group leader may have priority for display on the viewer of the first user over that of the second user.

In another aspect, the invention is a method of introducing people with common reading interests.

In another aspect, the invention is a method of providing online advertising.

In another aspect, the invention is a system for providing online advertising.

In another aspect, the invention is a method of supplying text books.

In another aspect, the invention is a system for providing text books.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A computer-based system for allowing a first user in a community of users to read an annotated web-based document (WBD) and associated annotations, the system comprising:
a WBD;
a plurality of annotations associated with the WBD, each annotation associated with one or more filterable fields where each filterable field may store a description related to the annotation or to a second user in the community of users who created the annotation, and where each annotation may be associated with an area of the WBD; and
a filter controlled by the first user, where the filter selects one or more annotations from the plurality of annotations based on the instructions of the first user and the information in the filterable fields.

2. The system of claim 1, where the WBD is hosted on an array of servers.

3. The system of claim 2, where the annotations are hosted on the same array of servers.

4. The system of claim 1, where the plurality of annotations was created by the community of users.

5. The system of claim 1, where the WBD is comprised of one or more pages and each page has a spacial coordinate system, and one or more annotations is associated with a set of coordinates in a page of the WBD.

6. The system of claim 5, where the filter selects one or more annotations from the plurality of annotations based upon a set of coordinates chosen by the first user.

7. The system of claim 1, where one or more of the filterable fields stores a ranking generated by the community of users.

8. The system of claim 6, where the ranking is a ranking of the quality of the annotation.

9. The system of claim 6, where the ranking is a ranking of the quality of a second user.

10. The system of claim 1, where one of the filterable fields stores a defined quality type chosen by the annotator.

11. The system of claim 10, where the quality type is selected from the group consisting of further explanation, further reading, arguments in favor, arguments against, video, and music.

12. The system of claim 1, where the community is an educational class of users.

13. The system of claim 1, where the community is a group of friends.

14. The system of claim 1, where the community is led by a person who is a leader in the field of the publication.

15. The system of claim 14, where the first user pays a subscription fee to view the annotations of the leader.

16. The system of claim 1, further comprising an annotation recommendation engine.

17. The system of claim 16, where the annotation recommendation engine generates a personality profile based on information supplied by a user.

18. The system of claim 16, where the annotation recommendation engine generates a recommendation based upon a broad selection of all data stored in the system.

19. The system of claim 1, where the area of the WBD associated with an annotation may be displayed as a highlight.

20. The system of claim 19, where the annotation is concurrently displayed in an annotation box.
